(19) United States
(12) Patent Application Publication
(10) Pub. No.: US 2005/0088625 A1
(43) Pub. Date: Apr. 28, 2005

(54) Image projecting device

(75) Inventor: Shinichi Imade, Iruma-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 10/975,667

(22) Filed: Oct. 28, 2004

(30) Foreign Application Priority Data
Oct. 28, 2003 (JP) 2003-367786

(51) Int. Cl. G03B 21/00

(52) U.S. Cl. 353/31

(57) ABSTRACT

An image projecting apparatus for projecting an image based on input color image data, comprises an expression area setting section configured to set an expression area in a color space, in which expression is performable when the illumination light components of colors emitted by an illuminating section are modulated by a display device, and an illumination light amount controlling section configured to appropriately control an amount of each of the illumination light components emitted from the illuminating section in each of frame time periods, in accordance with the color image data and the expression area set by the expression area setting section.

### CROSS-REFERENCE TO RELATED APPLICATIONS

This application is based upon and claims the benefit of priority from prior Japanese Patent Application No. 2003-367786, filed Oct. 28, 2003, the entire contents of which are incorporated herein by reference.

### BACKGROUND OF THE INVENTION

1. Field of the Invention

The present invention relates to an image display apparatus for displaying an image, and in particular an image projecting apparatus for projecting an image formed on a display device onto a projection surface with an illumination light from a light source in accordance with input image data, such that the image can be observed by an observer.

2. Description of the Related Art

As an image display apparatus for displaying an image, an apparatus is provided which uses a display device such as a liquid crystal or a micro mirror to control the transmission amount or reflection amount of an illumination light from an illumination device, modulate the illumination light, and form and display a gray-scale image. A liquid crystal monitor, a projector and the like are provided as the above apparatus. To display a color image, as is often the case, illumination light components of primary colors are separately modulated, and are spatially combined or are combined while being emitted at different timings, thereby forming a color image. When a color image is displayed, it is necessary to adjust the combination ratio of the light components of primary colors with respect to balance, in order to ensure a high color reproducibility. Thus, generally, when input image data items regarding the primary colors are the same as each other, a so-called “white balance” is fixedly adjusted such that the combination of the colors looks white.

In general, illumination light components of primary colors are generated by fixedly separating light components of primary colors from light emitted from a white-light lamp by using a color separation optical element such as a dichroic mirror or a color filter. Thus, the illumination amount of the light components of primary colors cannot be flexibly controlled. Therefore, at an initial stage, the balance of the light components of primary colors is optically set to satisfy a predetermined ratio, thereby adjusting the white balance. Alternatively, the amount of modulation by the display device based on the input image data is corrected according to a predetermined conversion rule, thereby adjusting the white balance.

On the other hand, the upper limit of the brightness of illumination light or that of a displayed image obtained due to modulation by a display device can be more reliably set to the maximum, when the image is formed with illumination light components of primary colors the outputs of which are each set at the maximum. However, in general, there are no light sources which emit illumination light components of primary colors such that their maximum outputs are “white-balanced” by chance. Thus, in the above case, the white balance is lost as explained above, and inevitably the color reproducibility lowers. That is, in order to ensure that the brightness of the illumination light is the maximum, a high color reproducibility cannot be ensured, and in order to obtain a high color reproducibility, the light source cannot be made to emit the maximum amount of illumination light.

As a method for solving such a problem, a method disclosed in, e.g., Jpn. Pat. Appln. KOKAI Publication No. 2002-51353 is known. According to the method, only when the gradation levels indicated by image data items regarding primary colors which are included in the input image data are all the maximum or the minimum, an image is displayed by illumination light components of primary colors the outputs of which are the maximum. In the other cases, it is displayed in such a way as to maintain a predetermined white balance. Therefore, when the above gradation levels are all the maximum or minimum, the brightness of the displayed image is the maximum or minimum, but the color balance of the image is lost. Thus, generally, such a state is not recognized as a state in which a white balance is maintained. However, the brightness of the image can be increased without relatively worsening the color balance.

Furthermore, Jpn. Pat. Appln. KOKAI Publication No. 2002-82652 discloses a so-called plane sequential type of image display apparatus, and an embodiment of the apparatus in which white illumination is performed each time light of each of primary colors is emitted. In the plane sequential of image display apparatus, illumination light components of primary colors are successively emitted onto a display device, and they are combined into an image to be displayed, while being viewed with observer's eyes. The method disclosed in the Publication is intended to improve the brightness of a produced image by emphasizing a white image component corresponding to a white image data item included in input image data. In a number of conventional plane sequential system of image display apparatuses, no image is displayed at the time of effecting switching between illumination light components of primary colors and between modulated images at a display device which correspond to the illumination light components, in order to prevent lowering of the quality of a displayed image, which would occur due to mixing of the color components at the time of effecting the above switching. However, the time for which illumination light is applied is shortened by the time for which no image is displayed, thus lowering the brightness of the displayed image. The technique of Jpn. Pat. Appln. KOKAI Publication No. 2002-82652 is intended to solve such a problem. However, in the technique of the Publication, the time period for which each of light components of primary colors is applied and that for which white illumination is performed are fixedly set at predetermined time periods.

The apparatus which is of such a plane sequential type as described above is not limited to an image display apparatus. To be more specific, there are provided plane sequential type of apparatuses which adjust and set the balance of the amounts of illumination light components of primary colors in accordance with various purposes. For example, in such a plane sequential type of electron endoscope as disclosed in Jpn. Pat. Appln. KOKAI Publication No. 2002-112962, the balance of illumination light components of primary colors is adjusted and set to correct the unbalance of the spectral sensitivity of an image pickup sensor.

The techniques disclosed in the above Publications are intended to increase the upper limit of the brightness of an image displayed by an image display apparatus, without excessively worsening the color balance of the image, and to obtain an image with a high reproducibility by adjusting the color balance of illumination light, thus adjusting the characteristics of an image pickup system.

### BRIEF SUMMARY OF THE INVENTION

According to an aspect of the present invention, there is provided an image projecting apparatus for projecting an image based on input color image data, comprises:
an illuminating section configured to emit illumination light components of colors such that an amount of each of the illumination light components of colors is adjustable in accordance with a driving current value and a driving time period;
a display device configured to perform modulation processing based on a color image data piece of the input color image data which is associated with one of the illumination light components of colors which is emitted from the illuminating section;
an expression area setting section configured to set an expression area in a color space, in which expression is performable when the illumination light components emitted by the illuminating section are modulated by the display device; and
an illumination light amount controlling section configured to appropriately control an amount of each of the illumination light components emitted from the illuminating section in each of frame time periods, in accordance with the color image data and the expression area set by the expression area setting section.

According to an another aspect of the present invention, there is provided an image projecting apparatus for projecting an image based on input color image data, comprises:
illuminating means for emitting illumination light components of colors such that an amount of each of the illumination light components of colors is adjustable in accordance with a driving current value and a driving time period;
a display device for performing modulation processing based on a color image data piece of the input color image data which is associated with one of the illumination light components of colors which is emitted from the illuminating means;
expression area setting means for setting an expression area in a color space, in which expression is performable when the illumination light components emitted by the illuminating means are modulated by the display device; and
illumination light amount controlling means for appropriately controlling an amount of each of the illumination light components emitted from the illuminating means in each of frame time periods, in accordance with the color image data and the expression area set by the expression area setting means.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an optical structure of an image projecting apparatus according to a first embodiment of the present invention.

FIG. 2 is a wave-form for use in explaining output sequences of illumination light components.

FIG. 3 is a view showing an electrical structure of the image projecting apparatus according to the first embodiment.

FIG. 4 is a wave-form for use in explaining output sequence of two illumination light components of primary colors.

FIG. 5 is a view for use in explaining a method for calculating a color balance vector.

FIG. 6 is a view for use in explaining another method for calculating a color balance vector.

FIG. 7 is a view showing the light amount of a displayed image X or Y at an arbitrary pixel in an image display range in which an image can be displayed by illumination light only (in the case where it is formed by using the maximum gradation range without modulating illumination light due to a display device).

FIG. 8 is a view for use in explaining a set line of illumination light components X and Y in terms of the illumination time periods of the illumination light components X and Y.

FIG. 9 is a view for use in explaining a color display range of a displayed image which is set in consideration of modulation by the display device.

FIG. 10 is a flowchart of an operation for setting color display ranges of vectors c and w.

FIG. 11 is a view showing the color distribution of an input color image.

FIG. 12 is a view showing the relationship between a color valance vector and the display range of a displayed image.

FIG. 13A is a view showing a displayable area obtained in the case where the display range of a color component (color balance vector w) included in all image data pieces is set to be small, and the display range of a color display vector c of a time division illumination component is set to be great.

FIG. 13B is a view showing a displayable area obtained in the case where the display range of the color balance vector w is set to be intermediate.

FIG. 13C is a view showing a displayable area obtained in the case where the display range of the color balance vector w is set to be great, and the display range of the color display vector c of the time division illumination component is set to be small.

FIG. 14 is a view for use in explaining a method for converting component data on the vectors w and c.

FIG. 15 is a flowchart of an operation for setting color display ranges of the vectors c and w in an image projecting apparatus according to a second embodiment of the present invention.

FIG. 16 is a view for use in explaining a method for setting the color display ranges of the vectors c and w in the image projecting apparatus according to the second embodiment.

FIG. 17 is a view showing the structure of an image projecting apparatus according to a third embodiment of the present invention.

FIG. 18 is a view showing the data format of input image data in the image projecting apparatus according to the third embodiment.

FIG. 19 is each of light engines for use in an image projecting apparatus according to a fourth embodiment of the present invention.

FIG. 20 is a view showing the structure of the image projecting apparatus according to the fourth embodiment.

FIG. 21 is a view showing the structure of an image projecting apparatus according to a fifth embodiment of the present invention.

FIG. 22 is a view showing the structure of an image projecting apparatus according to a sixth embodiment of the present invention.

FIG. 23 is a view showing a rewritable electronic paper recording apparatus to which the image projecting apparatus is applied, as a seventh embodiment of the present invention.

### DETAILED DESCRIPTION OF THE INVENTION

The embodiments of the present invention will be explained with reference to the accompanying drawings.

### THE FIRST EMBODIMENT

As shown in FIG. 1, an image projecting apparatus according to the first embodiment is provided to project an image formed on a display device onto a projection surface (screen 1) with an illumination light from a light source in accordance with input image data, such that the image can be observed by an observer. The image projecting apparatus is a single plate type of image projecting apparatus which uses a refection type of display element called “DMD” (trademark). The DMD is a two-dimensional micro mirror deflection allay. It is disclosed in detail in, e.g., Jpn. Pat. Appln. KOKAI Publication No. 11-32278 and U.S. Pat. No. 6,129,437, and their explanation will be omitted.

The image projecting apparatus uses as the light source a number of LEDs which emit respective light components having different colors, i.e., an LED 11R for emitting a red (R) light component, an LED 11G for emitting a green (G) light component and an LED 11B for emitting a blue (B) light component. The LEDs 11R, 11G and 11B are successively lit in different time periods. The light components emitted from the LEDs 11R, 11G and 11B are incident onto respective taper rods 12R, 12G and 12B. Each of the taper rods 12R, 12G and 12B is formed such that its light-emitting end is larger in area than its light-incident end, and converts diffused light from an associated LED to decrease the NA of the light, i.e., it converts the diffused light into substantially parallel light. The light from each of the taper rods 12R, 12G and 12B is directed to a predetermined direction by a dichroic cross prism 13. Then, after passing through a relay lens 14, the light is reflected by a reflecting mirror 15 onto a DMD 16. The light is modulated by the DMD 16, and is then projected as projection light 18 onto a projection screen (screen 1) through a projection lens 17. In this case, the reflecting mirror 15 is designed to have a curvature such that the light output from the dichroic cross prism 13 and the light incident on a light receiving surface of the DMD 16 form an image. In such a manner, a critical illumination system is provided to have the above structure. The light receiving surface of the DMD 16 has a rectangular shape, and the dichroic cross prism 13 is made to output light the rectangular shape having the aspect ratio which depends on the aspect ratio of the light receiving surface of the DMD 16. The above structure can be compactly provided in the housing (not shown) of an image projecting apparatus, since the optical path is folded. The optical path is designed such that light not incident from the DMD 16 on the projection lens 17, i.e., so-called “off light”, is not incident on the reflecting mirror 15 or a light output side of the dichroic cross prism 13.

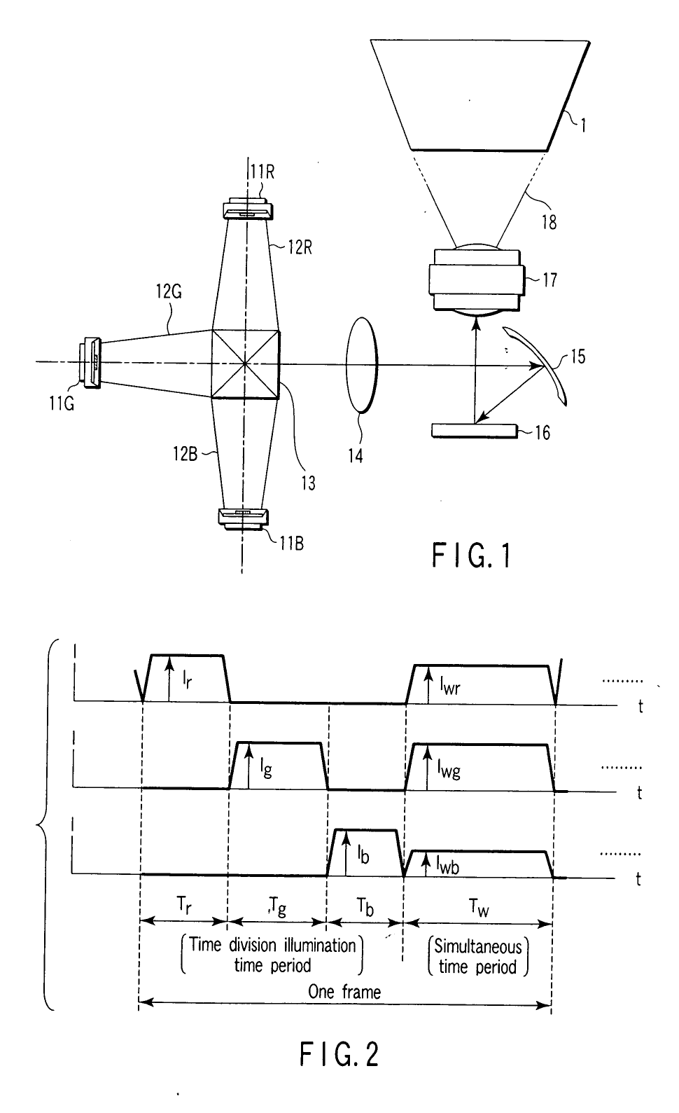

In such a single plate type of image projecting apparatus, the LEDs 11R, 11G and 11B are lit in different time periods. In particular, in the first embodiment, the intensity of emitted light and emission time of light are controlled by using four sequences including a sequence for obtaining illumination light of a predetermined color by lighting at least two of the LEDs 11R, 11G and 11B, and a sequence, for example, for obtaining white illumination light by lighting all the LEDs 11R, 11G and 11B as show in FIG. 2. Due to this control, a desired amount of illumination light is obtained. It should be noted that FIG. 2 is a timing chart showing the lighting timings of R, G and B, in which a vertical axis indicates the intensity of emitted light (current for driving each LED which is proportional to the intensity of light), and a horizontal axis indicates time. One frame consists of a time division illumination time period (first time period) and a simultaneous illumination time period (second time period). In the time division illumination time period, the LEDs 11R, 11G and 11B are lit in respective time periods, and in the simultaneous illumination time period, the LEDs 11R, 11G and 11B are all lit. The amount of illumination light corresponds to the product of the intensity of emitted light and the time period in which light is emitted (which will be hereinafter referred to as emission time period). The amount of illumination light each of R, G and B is the sum of the amount of illumination light in the time division illumination time period and that in the simultaneous illumination time period, and is thus expressed by the following equations (1):

$$\{ \begin{matrix}\text{the amount of illumination light} \\ of R \text{:} {L}_{r} = ( {I}_{r} \times {T}_{r} ) + ( {I}_{wr} \times {T}_{w} ) \\ \text{the amount of illumination light} \\ of G \text{:} {L}_{g} = ( {I}_{g} \times {T}_{g} ) + ( {I}_{wg} \times {T}_{w} ) \\ \text{the amount of illumination light} \\ of B \text{:} {L}_{b} = ( {I}_{b} \times {T}_{b} ) + ( {I}_{wb} \times {T}_{w} )\end{matrix} \qquad ( 1 )$$

The amounts of R. G and B illumination light components in the simultaneous illumination time period, which are denoted by (I_{wr}×T_{w}), (I_{wg}×T_{w}) and (I_{wb}×T_{w}), respectively, are controlled such that the amounts of the R, G and B light components emitted from the LEDs 11R, 11G and 11B, which are denoted by I_{wr}, I_{wg}, and I_{wb}, respectively, are made coincident with the component ratio of a color balance vector which will be explained later. The amounts of R, G and B illumination light components and display data of the DMD 16 are set in accordance with input image data in the following manner.

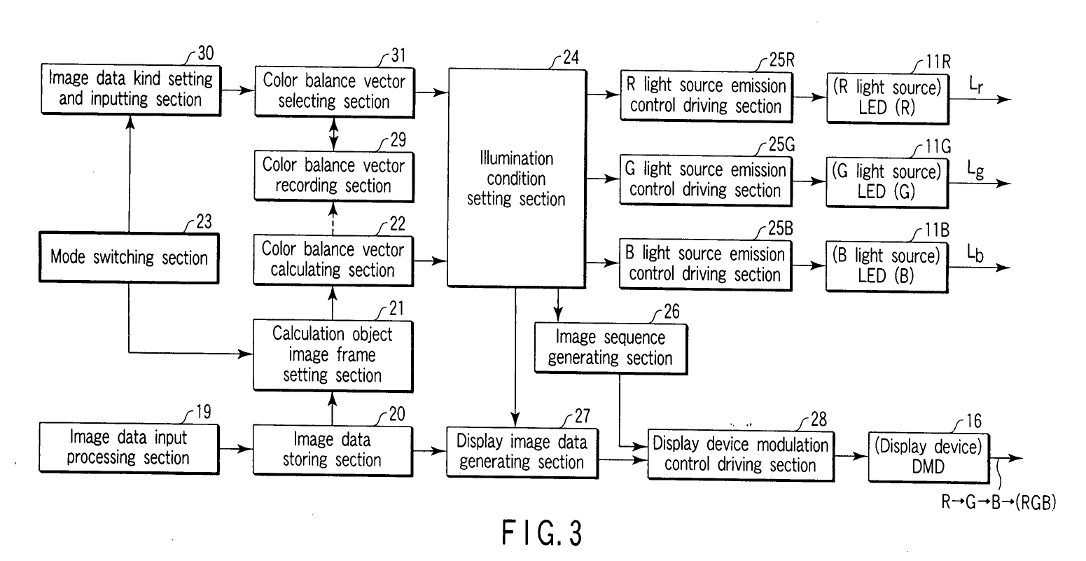

As shown in FIG. 3, image data output from an image outputting apparatus not shown such as a personal computer or a video device is acquired by an image data input processing section 19, and the acquired image data is once stored in an image storing section 20. The image data stored in the image data storing section 20 is read out by a calculation object image frame setting section 21, and the range of image data to be determined as one calculation object image unit is set, the image data being used to determine color distribution of pixels which is to be used at a color balance vector calculating section 22 at a stage subsequent to the calculation object image frame setting section 21.

For example, suppose the input image data is data of a still image for presentation. To the background of the still image, as is often the case, only one color is applied. Therefore, one report material comprising a number of image frames is determined as one calculation object image unit. If the input image data is data of a still image of a nature scene, it is effective that one frame is determined as one calculation object image unit.

On the other hand, when data of a moving image is input as the image data, a series of image frames in the moving image, e.g., image frames constituting one scene, are determined as one calculation object image unit. In the case of handling compressed data such as an MPEG in which data compression processing is carried out with respect to between frames which are successive on a time series basis, the following method can be applied: the timing of effecting switching between scenes each made by image frames (which will be hereinafter referred to as scene change) is specified by the position of a frame wherein the amount of compressed data is greatly large, as compared with the other frames. Also, as another method, it can be considered that the value of a correlation between the frames is continuously detected, and a rapid variation of the color or brightness is detected, to thereby specify the timing of the above scene change. In addition, if moving image data is generated in a format in which information regarding the above scene change is added, it is convenient, since the information can be easily utilized.

How the size of one calculation object image unit is determined may be arbitrarily designated by an operator with a mode switching section 23.

The color balance vector calculating section 22 calculates a color balance vector from image data on a calculation object image frame which is given by the calculation object frame setting section 21, in a manner described later, and recognizes an area in which an image corresponding to the input image data is distributed in color space. The color balance vector calculated by the color balance vector calculating section 22 is input to an illumination condition setting section 24. The illumination condition setting section 24 sets the amounts of illumination light components of primary colors (R, G and B). The amounts of the illumination light components which are set by the illumination condition setting section 24 are controlled based on the intensities of the emitted light components and the emission time periods of R, G and B light sources serving as the LEDs 11R, 11G and 11B in accordance with the above equation (1). The illumination condition setting section 24 sends signals or data items which indicate the above light intensities (of the light components of primary colors (R, G and B)) and emission time periods to R, G and B light source emission control driving sections 25R, 25G and 25B, and the LEDs 11R, 11G and 11B are made to emit the light components of the primary colors R, G and B, respectively. The amounts of these emitted light components can be controlled by varying the values of current to be supplied to the LEDs 11R, 11G and 11B. However, needless to say, a voltage may be applied to the LEDs 11R, 11G and 11B instead of current, or current and a voltage may be both applied.

The illumination condition setting section 24 sends signals or data items, which indicate patterns of the emission time periods of the R, G and B light sources and the light intensities of the emitted light components of primary colors R, G and B therefrom, to an image sequence generating section 26 and a display image data generating section 27. The image sequence generating section 26 generates image sequences which indicate the illumination time periods of the light components of primary colors R, G and B and the switching timing of the DMD 16, etc., and sends them to a display device modulation control driving section 28. The display image data generating section 27 divides the image data stored in the image data storing section 20 into two image data items, and send the two image data items to the display device modulation control driving section 28. One of the two image data items comprises image data items corresponding to images of primary colors R, G and B which are to be projected in the above time division illumination time period, and the other also comprises image data items corresponding to images of primary colors R, G and B which are to be projected in the simultaneous illumination time period. The display device modulation control driving section 28 drives and controls the DMD 16, which serves as a display device, in accordance with the sent image sequence and image data items.

The color balance vector calculated by the color balance vector calculating section 22 is recorded in a color balance vector recording section 29. Then, when similar image data is input, processing for calculating a color balance vector can be omitted by using the color balance vector recorded in the color balance vector recording section 29. Furthermore, in the color balance vector recording section 29, color balance vectors may be recorded in advance with respect to the kinds of conceivable image data items, respectively. For example, an image for medical treatment which is obtained by imaging an inner part of a living body or an image of a colored sample which is obtained by a microscope includes a number of specific color components. Therefore, with respect to such an image, it is reasonable that color balance vectors are determined in advance, and are stored in the color balance vector recording section 29, and any of them can be selected and utilized as a set value. That is, it is not necessary to calculate a color balance vector each time image data is input. Therefore, the image projecting apparatus according to the first embodiment further comprises an image data kind setting and inputting section 30 and a color balance vector selecting section 31. The image data kind setting and inputting section 30 enables a user to designate and input desired data kind. In accordance with an image kind ID from the image data kind setting and inputting section 30, the color balance vector selecting section 31 is designed to select an associated color balance vector from those recorded in the color balance vector recording section 29.

Furthermore, the mode switching section 23 may be provided to enable the user to effect switching between an “appropriate color balance mode” in which a color valance vector is calculated and a “fixed color valance mode” in which a recorded color balance vector is used. The “fixed color balance mode” is a mode for enabling the operator to select one of color balance vectors which are respectively set in advance in association with the kinds of images categorized in accordance with purposes, such as an image of an inner part of a living body, which is used in medical treatment. In this case, there is a method in which switches, etc., for use in selecting one of the above set color balance vectors are provided, and the operator manually operate the switches to select a set color balance vector. This is the simplest of methods of selecting one of the above set color balance vectors. On the other hand, the “appropriate color balance mode” is a mode in which with respect to a group of object images of input images, appropriate color balance vector is calculated and applied. Furthermore, the mode switching section 23 may be formed to have a mode in which a control based on such a color balance vector is carried out and a mode in which the control is not carried out.

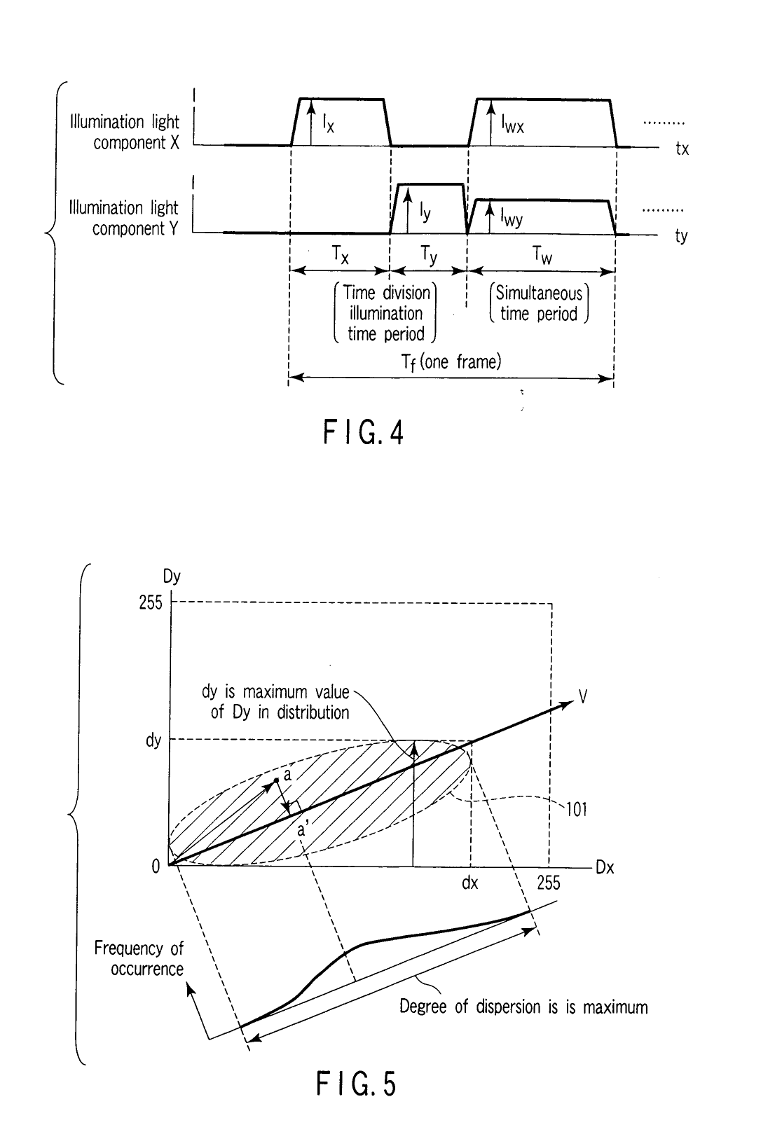

The operation of the image projecting apparatus according to the first embodiment will be explained in detail. It should be noted that suppose images of primary colors are formed in a two-dimensional color space by two illumination light components X and Y (i.e., two illumination light components of primary colors), in order to simplify the explanation. Also, suppose as shown in FIG. 4, the intensities of emitted illumination light components X and Y in different time periods (the time division illumination period), which are denoted by Iₓ and I_{y}, are equal to each other, and their illumination light amounts are proportional to their emission time periods, in order to simplify the explanation. The intensities of emitted illumination light components X and Y at the same time period (the simultaneous illumination time period), which are denoted by I_{wx} and I_{wy}, are appropriately increased/decreased. That is, in an output sequence of each of the illumination light components X and Y, their amounts are expressed by the following equations (2):

$$\{ \begin{matrix}{L}_{x1} = {I}_{x} \times {T}_{x} , {L}_{x2} = {I}_{wx} \times {T}_{w} \\ {L}_{y1} = {I}_{y} \times {T}_{y} , {L}_{y2} = {I}_{wy} \times {T}_{w} \\ the amount of illumination light component \\ X \text{:} {L}_{x} = {L}_{x1} + {L}_{x2} \\ \text{the amount of illumination light component} \\ Y \text{:} {L}_{y} = {L}_{y1} + {L}_{y2} \\ {T}_{x} + {T}_{y} + {T}_{w} = {T}_{f} ( constant value ) \end{matrix} \qquad ( 2 )$$

First, how a color balance vector “V” is calculated by the color balance vector calculating section 22 will be explained.

The color balance vector calculating section 22 determines the color balance vector in a manner disclosed in, e.g., FIG. 5. To be more specific, as shown in FIG. 5, a color distribution 101 of image data is obtained, when the color vector of each of pixels which is indicated in image data regarding a calculation object image frame set by the calculation object image frame setting section 21 is plotted, where a horizontal axis indicates a data value Dx of a primary color X, and a vertical axis indicates a data value Dy of a primary color Y. In the color distribution 101, where dx is the maximum value of the primary color X, and dy is that of the primary color Y, the color balance vector V is determined to satisfy the following equation (3):

$$V = ( \frac{ⅆ x}{\sqrt{ⅆ {x}^{2} + ⅆ {y}^{2}}} , \frac{ⅆ y}{\sqrt{ⅆ {x}^{2} + ⅆ {y}^{2}}} ) \qquad ( 3 )$$

When the color vector of each of the pixels which is indicated in the image data regarding the calculation object image frame is projected on the color balance vector V (for example a→a′), distribution of the frequency of occurrence of color vectors is obtained as shown in lower part of FIG. 5. This processing is successively subjected to this processing, while changing the inclination of the color balance vector V, i.e., while successively changing the value dx of the primary color X. Then, the color balance vector V at the time when the degree of dispersion in projection distribution is maximized is determined as a desired color balance vector. Such a desired color balance vector in which the degree of dispersion is the largest is determined by using a neural network and KL conversion usually applied to image processing and coding processing, etc.

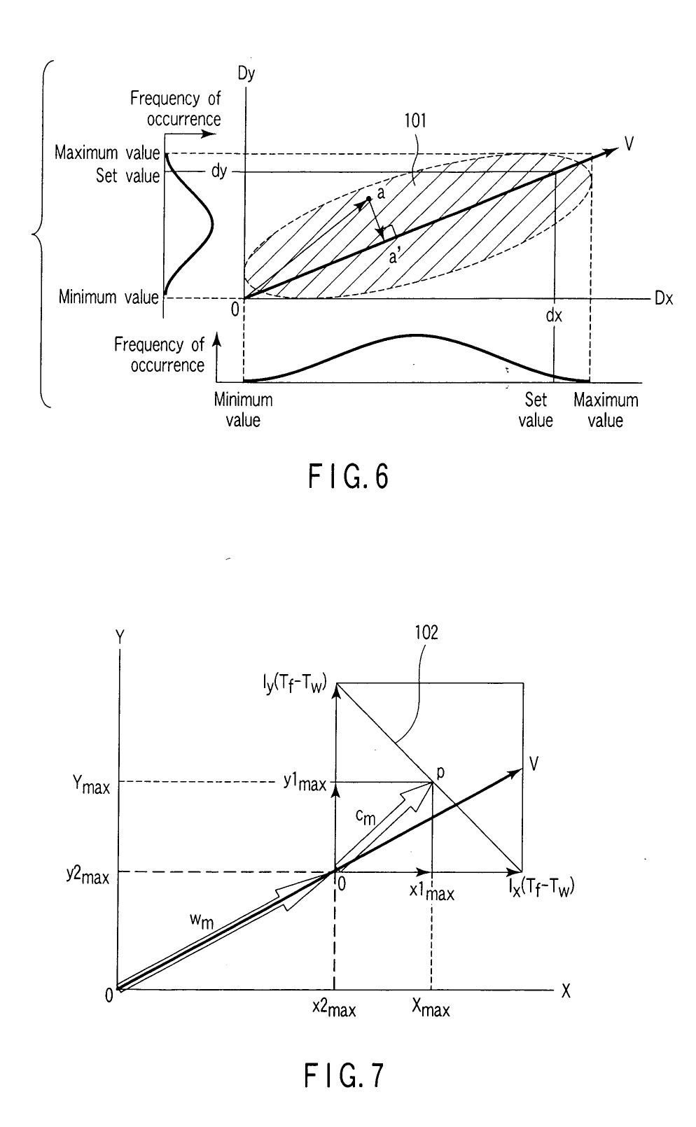

Alternatively, a histogram of each of brightness values in the input image data is determined, and the maximum of brightness values is determined by using the histograms, which are values at which observer does not feel unnatural about a displayed image, even if they are deleted as brightness values. In addition, an area in which the input data is distributed is recognized by using the maximum brightness value of each of the illumination light components of the colors, and a color balance vector is calculated. More specifically, first, an occurrence frequency distribution of color vectors of light components projected, which are obtained at coordinate axes Dx and Dy, is determined from color distribution of the image data, as shown in FIG. 6. Then, from the occurrence frequency distribution with respect to the coordinate axis Dx, a set value dx indicating a predetermined occurrence rate is determined at a value between falls within the range of the maximum and minimum values of the coordinate axis Dx. Similarly, from the occurrence frequency distribution with respect to the coordinate axis Dy, a set value dy indicating a predetermined occurrence rate is determined at a value which falls within the range of the maximum and minimum values of the coordinate axis Dy. From the values dx and dy determined in the above manner, the appropriate color balance vector V is determined by the above equation (3).

The values dx and dy are set such that even if pixels having coordinate values which exceed the values dx and dy are replaced by pixels the values of which are less than the values dx and dy, they do not look unnatural. In order to find the degree to which the pixels do not look unnatural, a number of observers actually check displayed images corresponding to a number of sample image data, and determine the above degree based on their empirical rules. The above replacement can be achieved by using the method explained later.

The illumination condition setting section 24 determines the amounts of illumination light components of primary colors (R, G and B) based the calculated color balance vector. This will be explained in detail as follows. It should be noted that as stated above, suppose images of primary colors are formed in a two-dimensional color space by two illumination light components X and Y, in order to explain the explanation.

FIG. 7 shows the light amount of a displayed image X or Y at an arbitrary pixel, which is obtained when it is formed by using the maximum gradation range without modulating an illumination light component X or Y due to a display device X or Y. That is, it discloses a concept of the way of setting the conditions of the illumination light components X and Y. In this case, the set amounts of the illumination light components X and Y in the simultaneous illumination time period T_{w} shown in FIG. 4 are denoted by x2ₘₐₓ and y2ₘₐₓ in equations (4) indicated below. The component ratio of a maximum color valance vector denoted by wₘ consisting of the above set amounts x2ₘₐₓ and y2ₘₐₓ is set to be equal to that of the color balance vector V calculated in the above manner by the color balance vector calculating section 22. That is, the directions of these vectors are the same as each other.

$$\{ \begin{matrix}{x1}_{max} = {I}_{x} \cdot {T}_{x} , & {x2}_{max} = {I}_{wx} \cdot {T}_{w} \\ {y1}_{max} = {I}_{y} \cdot {T}_{y} , & {y2}_{max} = {I}_{wy} \cdot {T}_{w} \\ {x}_{max} = {x1}_{max} + {x2}_{max} , & {Y}_{max} = {y1}_{max} + {y2}_{max} \\ {T}_{f} = {T}_{x} + {T}_{y} + {T}_{w} & \end{matrix} \qquad ( 4 )$$

In the above equations (4), x1ₘₐₓ y1ₘₐₓ are the set amounts of the illumination light components X and Y in the time division illumination time period Tₓ or T_{y} shown in FIG. 4. However, the set amounts x1ₘₐₓ and y1ₘₐₓ are values which are determined when coordinates (x2ₘₐₓ, y2ₘₐₓ) are set as origin point. To be more specific, when one frame time T_{f} shown in FIG. 4 is given, and the simultaneous illumination time period T_{w} is determined, the set amounts x1ₘₐₓ and y1ₘₐₓ of the illumination light components X and Y in the time division illumination time period are determined in accordance with the ratio between the time periods Tₓ and T_{y} of the remaining time period “T_{f}−T_{w}”.

The end point of a maximum color display vector cₘ defining the maximum display range of color in the time division illumination time period can be set at a point on a set line 102 of the illumination light components X and Y shown in FIG. 7. It can also be said that the maximum color display vector cₘ indicates the total amount of the illumination light components in the time division illumination time period. Then, if only the illumination light component X is emitted in the entire remaining period “T_{f}−T_{w}”, the upper limit of the emitted illumination light component X is Iₓ(T_{f}−T_{w}), and the maximum of the above set amount x1ₘₐₓ of the illumination light component X can be set at Iₓ(T_{f}−T_{w}). In this case, T_{y} is zero. Similarly, if only the illumination light component Y is emitted in the entire remaining period “T_{f}−T_{w}”, the upper limit of the emitted illumination light component Y is I_{y}(T_{f}−T_{w}), and the maximum of the above set amount y1ₘₐₓ Of the illumination light component X can be set at I_{y}(T_{f}−T_{w}). In this case, Tₓ is zero. Therefore, the set amounts x1ₘₐₓ and y1ₘₐₓ can be set at values corresponding to the coordinates of a point P on the set line 102 of the illumination light components X and Y. The maximum color display vector cₘ indicates a color component vector of each of color components of images which can be displayed by the illumination light components X and Y in the time division illumination time period (T_{f}−T_{w}).

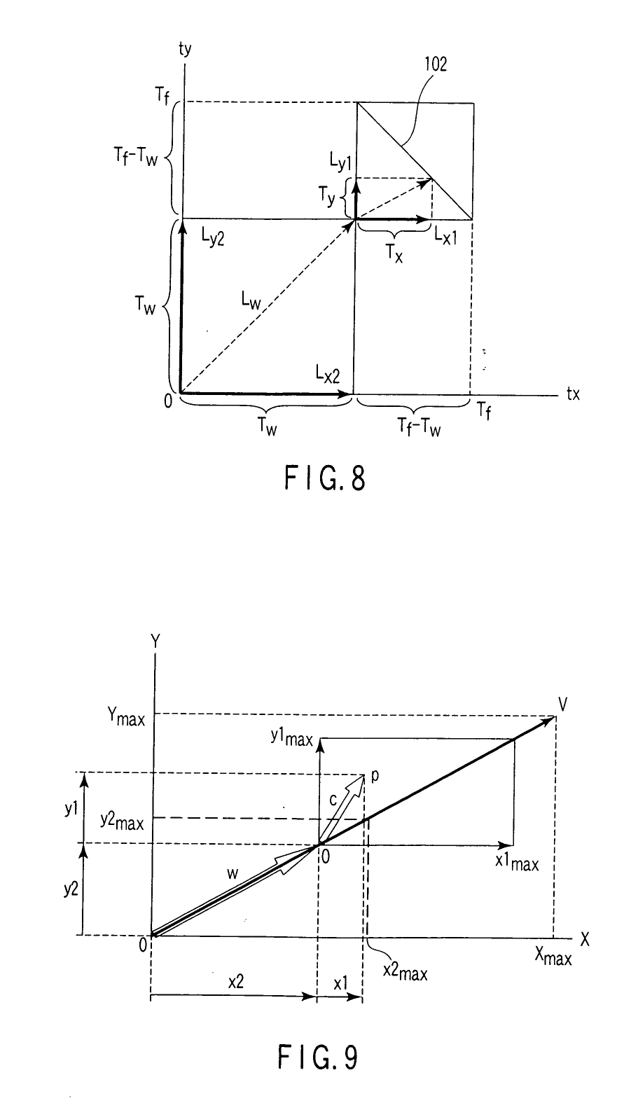

The set line 102 of the illumination light components X and Y can be set as shown in FIG. 8. To be more specific, FIG. 8 is a view showing the illumination time periods of the illumination light components X and Y, which are indicated by a horizontal axis tx and a vertical axis ty, respectively, where Lₓ₁, L_{y2} and L_{w} are the illumination light components X, Y and W (simultaneous illumination of the light components X and Y), respectively, and the lengths of arrows indicating the illumination light components X, Y and W correspond to the illumination time periods thereof, respectively. The amounts of the illumination light components X and Y can be set at values indicated by points on the set line 102 of the illumination light components X and Y, respectively. Furthermore, Tₓ+T_{y}=T_{f}−T_{w}. That is, after the illumination light component X is emitted in the time period Tₓ, and the illumination light component Y is then emitted in the time period T_{y}, the illumination light components X and Y are simultaneously emitted in the time period T_{w}. The total of these time periods (Tₓ, T_{y} and T_{w}) is the time period of one cycle of the above successive illumination of the illumination light components X and Y.

Next, the range of color reproduction of a displayed image in consideration of modulation will be explained. In the illumination time period Tₓ, the illumination light component X is modulated by the display device X. In the illumination time period T_{y}, the illumination light component Y is modulated by the display device Y. In the illumination time period T_{w}, the illumination light components X and Y are respectively modulated by the display devices X and Y at the same time and in the same manner.

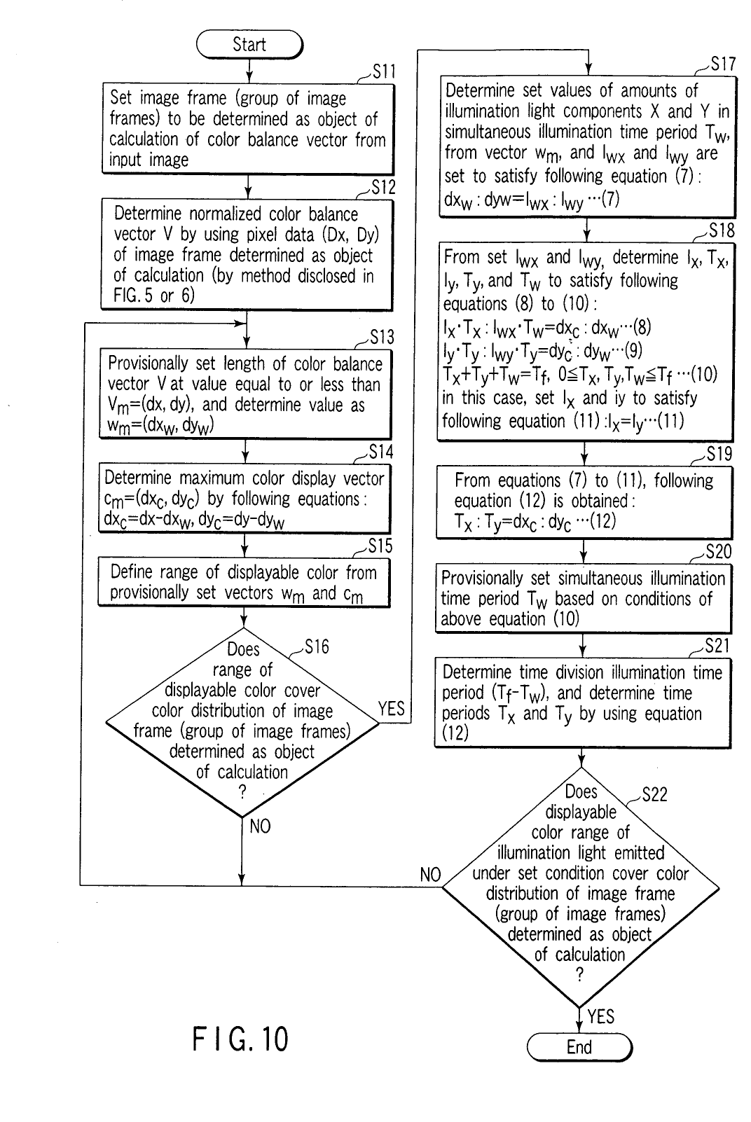

FIG. 9 is a view in which a horizontal axis indicates the amount of light at an arbitrary pixel in a displayed image X which is obtained by modulating the illumination light component X in the illumination time periods Tₓ and T_{w}, and a vertical axis indicates the amount of light at an arbitrary pixel in a displayed image Y which is obtained by modulating the illumination light component Y in the illumination time periods T_{y} and T_{w}. First, in the color space defined by the illumination light components X and Y, a color balance vector V is set which is balanced in specific color. As the color balance vector V, a color balance vector in which white balance is achieved is used, or a color balance vector which is obtained by setting specific color balance with respect to each image is used.

Arbitrary pixel in displayed image modulated by the display devices X and Y in the simultaneous illumination time period T_{w}, is changed as a vector w (=x2, y2) which has the light amounts x2ₘₐₓ and y2ₘₐₓ as the maximum values of the components and has a fixed component ratio defined by the maximum values, and a color range corresponding to the changing range of the vector w is expressed. The direction of the arrow of the vector w is same as that of the color balance vector V. That is, the component ratio of the vector w is equal to that of the color balance vector V.

On the other hand, in arbitrary pixels in images displayed by the display devices X and Y, which are obtained after modulation, in the time division illumination time period Tₓ or T_{y}, the images are expressed to have a vector c (=x1, y1) in which the light amounts x1ₘₐₓ and y1ₘₐₓ are the maximum values of the components in color range. The ratio between the light amounts x1ₘₐₓ and y1ₘₐₓ may be set to be the same as each other or different from each other. It is, however, preferable that the color range covered by the vectors w and c be coincident with that of the input image data.

The light amounts x2ₘₐₓ and y2ₘₐₓ and the light amounts x1ₘₐₓ and y1ₘₐₓ are set to satisfy the following equations (5):

$$\{ \begin{matrix}{x1}_{max} \text{:} {x2}_{max} = ( {I}_{x} \cdot {T}_{x} ) \text{:} ( {I}_{wx} \cdot {T}_{w} ) \\ 0 \leq x1 \leq {x1}_{max} , 0 \leq x2 \leq {x2}_{max} \\ {y1}_{max} \text{:} {y2}_{max} = ( {I}_{y} \cdot {T}_{yx} ) \text{:} ( {I}_{wy} \cdot {T}_{w} ) \\ 0 \leq y1 \leq {y1}_{max} , 0 \leq y2 \leq {y2}_{max} \\ {L}_{x1} : {L}_{y1} = {x1}_{max} : {y1}_{max} \\ {L}_{x2} : {L}_{y2} = {x2}_{max} : {y2}_{max} \end{matrix} \qquad ( 5 )$$

At the arbitrary pixels, the displayed images are expressed to have a vector p (pixel vector) which is obtained by combining the vectors w and c. To be more specific, in the first embodiment, a method for displaying an image in arbitrary color have the following feature. First, illumination light having a specific color balance is modulated, to thereby form a first image. Then, a color component obtained by subtracting the color components of the first image from arbitrary color is modulated by using illumination light which can be independently modulated, to thereby form a second image. The first and second images are combined by utilizing persistence of vision, to thereby reproduce the arbitrary color.

In general, in a plane sequential type of image forming method, time division illumination can be solely applied or a combination of time division illumination and simultaneous illumination of light components whose color balance cannot be changed can be applied. On the other hand, the image projecting apparatus according to the first embodiment uses illumination light components whose balance can be changed in accordance with the image to be displayed, and can thus effectively achieve color reproduction, and effectively increase the brightness of the displayed image.

In the first embodiment, the appropriate movement ranges of the vectors w and c are set in units of one image data. Therefore, even in the case of handling a group of images as one unit, the necessary color range is completely covered.

The above setting of the color display ranges of the vectors c and w is carried out in a manner shown in FIG. 10. To be more specific, if such a color distribution 101 of image data as shown in FIG. 11 is given, an image frame (a group of image frames) to be determined as an object of calculation of a color balance vector is determined from an associated input image by the calculation object image frame setting section 21 (step S11). Then, in the color balance vector calculating section 22, a normalized color balance vector V is determined by using pixel data (Dx, Dy) of the image frame determined as the object of the calculation, as explained above with reference to FIG. 5 or 6 (step S12).

Next, in the illumination condition setting section 24, the length of the above color balance vector V is provisionally set to be equal to or less than Vₘ=(dx, dy), and is determined as wₘ=(dx_{w}, dy_{w}) (step S13). Then, the maximum color display vector cₘ=(dx_{c}, dy_{c}) is determined by the following equations (6) (step S14):

$$\{ \begin{matrix}ⅆ {x}_{c} = ⅆ x - ⅆ {x}_{w} \\ ⅆ {y}_{c} = ⅆ y - ⅆ {y}_{w}\end{matrix} \qquad ( 6 )$$

Thereafter, the range of displayable color is defined from the above provisionally set vectors wₘ and cₘ (step S15). Then, it is determined whether or not the range of the displayable color covers the color distribution of the image frame (group of image frames) determined as the object of the calculation (step S16). When it is determined that the range of the displayable color does not cover the above color distribution, the step is returned to the above step S13, and the above steps from the step S13 are successively repeated, after changing the length of the color balance vector V.

The relationship between the above-range of the displayable color and the color distribution varies in accordance with setting of the vectors wₘ and cₘ, which will be explained later in detail. Then, whether the setting is appropriate or not is determined based on a predetermined criterion for determining whether it is allowable or not with the sense of sight. Furthermore, How the color distribution looks varies in accordance with the spectral luminous efficiency. Therefore, if weights are assigned to color in consideration of the spectral luminous efficiency, a more satisfactory range of displayable color is set.

However, when it is determined that the range of the displayable color covers the color distribution, the set values of the amounts of the illumination light components X and Y in the simultaneous illumination time period T_{w} are determined from the provisionally set vector wₘ, and I_{wx} and I_{wy} are set to satisfy the following equation (7) (step S17):
dx_{w}:dy_{w}=I_{wx}:I_{wy} (7)

Then, from the set I_{wx} and I_{wy}, Iₓ, Tₓ, I_{y}, T_{y}, and T_{w} are determined to satisfy the following equations (8) to (10) (step S18):
Iₓ·Tₓ:I_{wx}·T_{w}=dx_{c}:dx_{w} (8)
I_{y}·T_{y}:I_{wy}·T_{w}=dy_{c}:dy_{w} (9)
Tₓ+T_{y}+T_{w}=T_{f}, 0≦Tₓ, T_{y}, T_{w}≦T_{f} (10)

In this case, Iₓ and I_{y} are set to satisfy the following equation:
Iₓ=I_{y} (11)
From the above equations (7) to (11), the following equation (12) is obtained (step S19):
Tₓ:T_{y}=dx_{c}:dy_{c} (12)

Then, the simultaneous illumination time period T_{w} is provisionally set based on the conditions of the above equation (10) (step S20). Thereafter, the time division illumination time period (T_{f}−T_{w}) is determined, and the time periods Tₓ and T_{y} are determined by using the above equation (12) (step S21). It is determined whether or not the displayable color range of illumination light emitted under the above set condition covers the color distribution of the image frame (group of image frames) determined as the object of the calculation (step S22). If it is determined that the above displayable color range does not cover the color distribution, the step is returned to the step S13, and the steps from the step S13 are successively repeated after changing the length of the color balance vector V.

In the step S22, when it is determined that the above displayable color range covers the color distribution, the operation ends. Then, the light sources and the display devices are controlled based on Iₓ, Tₓ, I_{y}, T_{y}, I_{wx}, I_{wy} and T_{w} set in the above manner.

The relationship between the color balance vector and the display range of the displayed image will be explained.

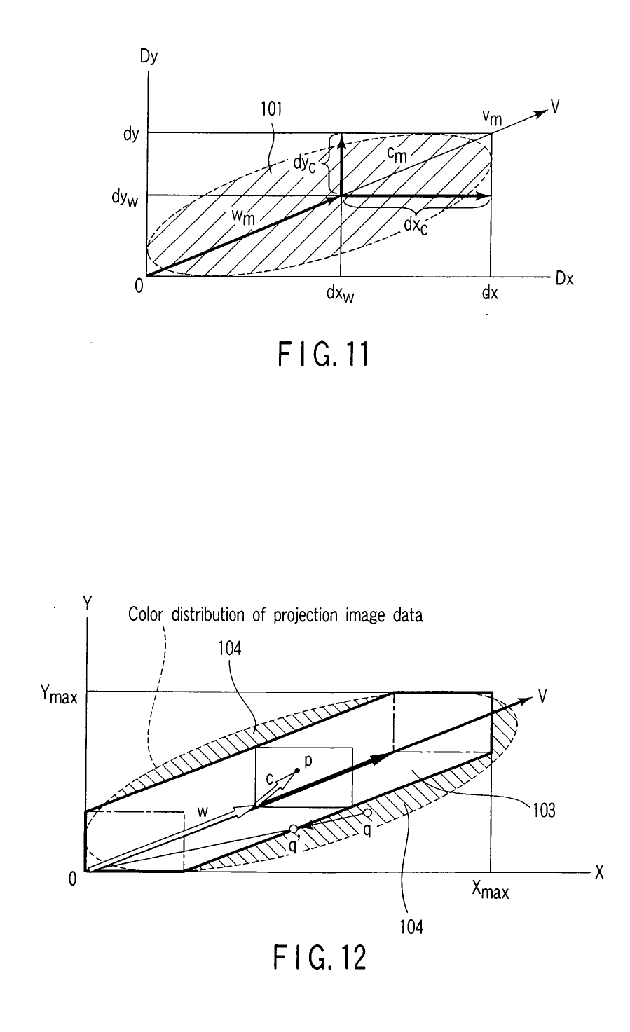

As shown in FIG. 12, a color component of a vector P indicating an arbitrary projection pixel is expressed by “vector w+vector c”. The vector p is a position vector. The displayable range of the vector p is a displayable area 103 as shown in FIG. 12. When the display range of the vector w is increased to be great, the amount of illumination light can be increased, but the display range of the vector c is decreased, thus reducing the displayable area 103. Inevitably, a non-displayable area 104 in which an image cannot be displayed is provided in an image corresponding to image data. Where a position vector corresponding to an arbitrary projection image in the non-displayable area 104 is denoted by q, the vector q needs to be expressed by any of the vectors in the displayable area 103. To be more specific, the point q is allocated to a point q′ which is located on a line extending between the origin point and point q, and which is the closest to the point q in the displayable area 103, whereby it is converted and expressed as the point q′. As a result, although the light amount is reduced, an image can be displayed while maintaining the color balance. That is, the observer can view the displayed image without feeling unnatural.

The above point q′ can be determined in other manners. For example, a point which is located closest to a point q in the same coordinate space of Euclidean space may be determined as the point q′. An allocation table may be prepared in advance, which indicates points determined based on displayed images which do not cause the observer to feel unnatural even if the points are applied in the above manner. That is, the above conversion may be carried out based on the assignment table. Furthermore, in order to perform the above allocation, it is effective to prepare a neural network. To be more specific, a neural network is made to learn based on supervisor's data obtained with the sense of vision, and allocation is carried out by using the neural network.

In a regular mode, the above color balance vector V is set such that white balance is ensured, and the display range of the vector c is set to be large. Furthermore, it is also functional that if the color distribution of an input image is unbalanced, the mode can be switched to an appropriate mode in which the color distribution is appropriately set in accordance with the image to be displayed, by the above calculation. It is convenient to properly use the regular mode and the appropriate mode such that the regular mode is applied to give priority to the color reproduction of the displayed image, and the appropriate mode is applied to give priority to the brightness of the displayed image. For example, they can be used properly as follows: the regular mode is applied to presentation associated with a design which weighs the color reproduction, and the appropriate mode is applied to business presentation in a situation in which the amount of illumination light cannot be reduced.

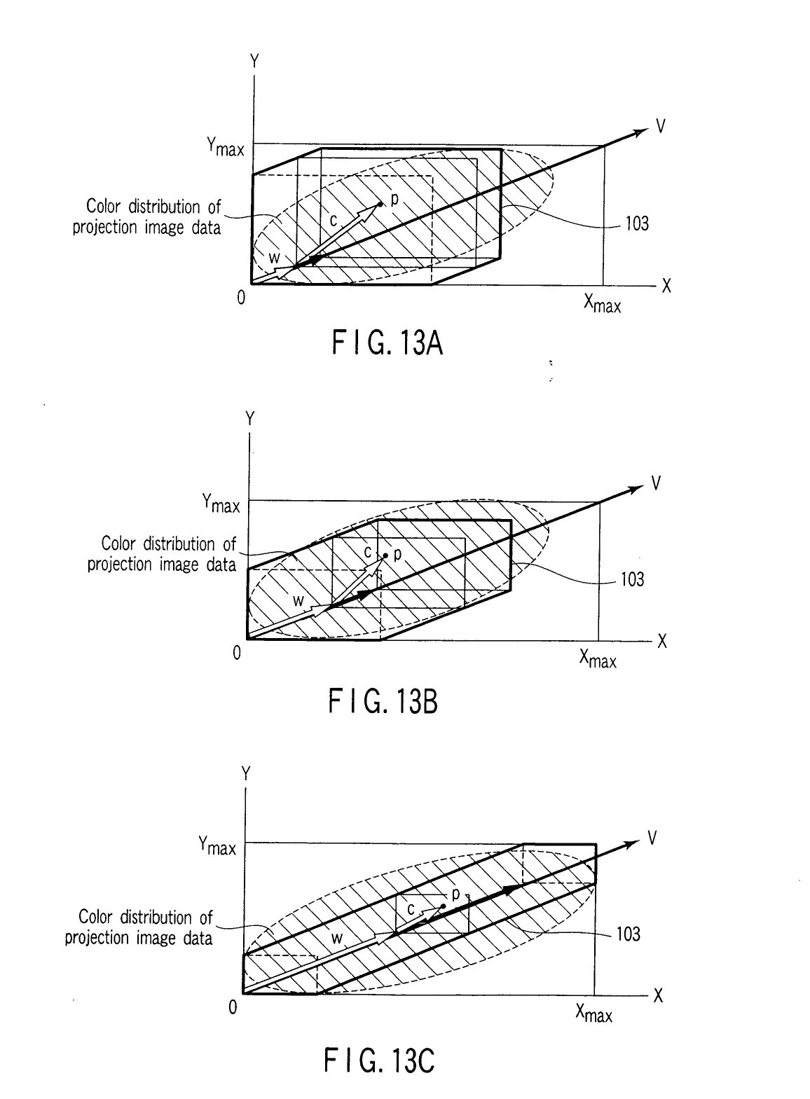

As described above, the relationship between the displayable color range and the color distribution varies in accordance with setting of the vectors wₘ and cₘ. This will be explained with reference to FIGS. 13A to 13C, which are conceptual diagrams showing how the displayable area 103 varies in accordance with the components of the color balance vector V, i.e., the ratio of the simultaneous illumination time period T_{w} to the one-frame time period T_{f}.

When the display range of a color component (color balance vector w) which is included in images corresponding to all image data is set to be small, and the display range of the color display vector c of a time division illumination component is set to be great, the displayable area 103 is shaped as shown in FIG. 13A. That is, in this case, although the display range of color is large, the simultaneous illumination time period Tw is small, and inevitably, the brightness cannot be made great. Therefore, this pattern can be applied as a mode which gives priority color reproduction.

When the display range of the color component (color balance vector w) which is included in images corresponding to all image data is set to be approximately intermediate, the displayable area 103 is shaped as shown in FIG. 13B. In this case, although the displayable area 103 is smaller than that in FIG. 13A, the brightness is greater than that in FIG. 13A.

When the display range of the color component (color balance vector w) which is included in images corresponding to all image data is set to be large, and the display range of the color display vector c of the time division illumination component is set to be small, the displayable area 103 is shaped as-shown in FIG. 13C. In this case, although the displayable area 103 is smaller than those in FIGS. 13A and 13B, and the color reproducibility is also lower than those in those in FIGS. 13A and 13B, the brightness is greater than those in FIGS. 13A and B. Therefore, this pattern is applied as a mode which gives priority to the brightness.

In order to ensure an effective light amount of a displayed image, it is preferable that the display image data generating section 27 perform the following data conversion. As shown in FIG. 11, the color distribution 101 of the input image data is applied to an area which satisfies “0≦Dx≦dx, 0≦Dy≦dy”. If the gradation level of the input image data can be expressed in 8 bits, and the range of the gradation level is 0 to 255, dy and dy are set at predetermined values in the range. The gradation level of an image to be projected on the screen 1 corresponds to an output after the illumination light passes through the display device. Thus, in the case where dx<255, and dy<255, when an image is projected while keeping the value of the input image data as it is, the vectors wₘ and cₘ are set such that the amounts of the associated illumination light components are excessively restricted by the display device. For example, when the color distribution of the input image data is not wide as in the case where dx<128 and dy<128, the amount of the illumination light is approximately halved.

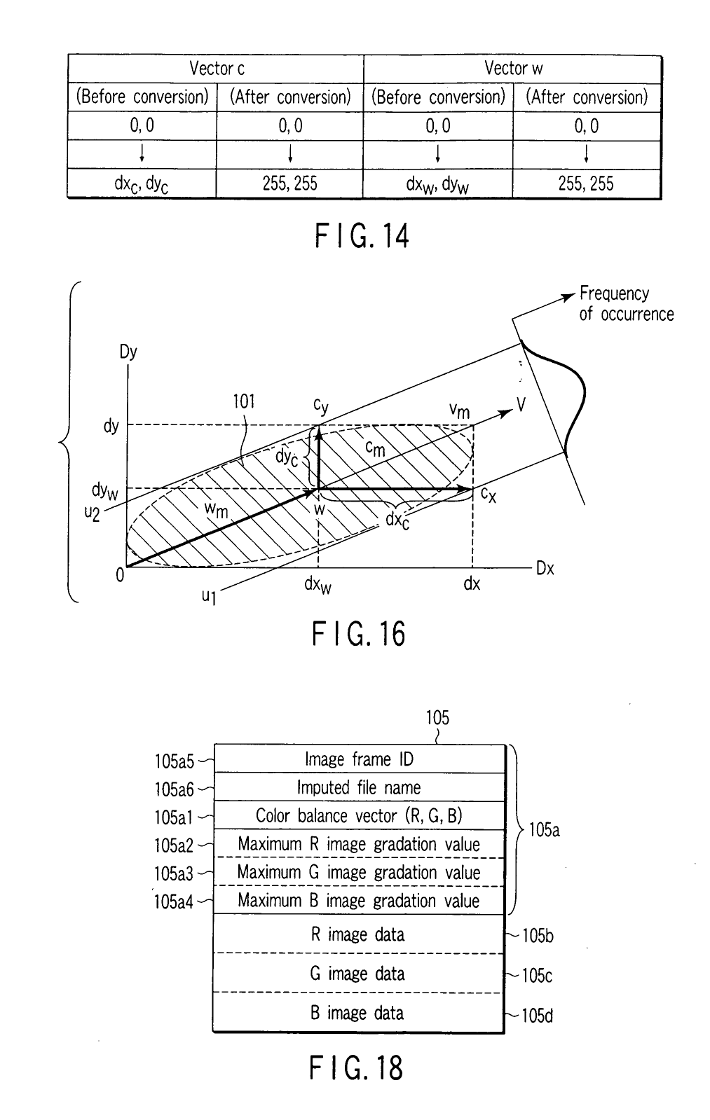

Furthermore, in the first embodiment, the gradation levels indicated by the vectors wₘ and cₘ can be each set in 8 bits at the maximum, since illumination light components respectively having the vectors wₘ and cₘ are projected in different time periods. However, for example, when dx=255, and dy=255, the advantage in which illumination light components can be used independently cannot be utilized. Therefore, the component values dx_{w} and dy_{w} of the vector wₘ are both converted into data of the maximum gradation level (255 in the above example), and the component values dx_{c} and dy_{c} of the vector cₘ are both converted into data of the maximum gradation level (255 in the above example), whereby the illumination light can be efficiently utilized. To be more specific, the vector wₘ is converted such that the amount of the illumination light in the simultaneous illumination time period is reflected as the light amount of a displayed image, and the vector wₘ is converted such that the amount of the illumination light in the time division illumination time period is reflected as the light amount of a displayed image. Therefore, when the component data on the vectors w and c is converted in a linear fashion to satisfy a relationship shown in FIG. 14, the effective light amounts of the displayed images are ensured.

### THE SECOND EMBODIMENT

The second embodiment of the present invention will be explained. With respect to the first embodiment, as the method of setting the color display ranges of the vectors c and w, it is stated that first, the vector w is provisionally set, and then the vector c is determined. On the other hand, in the second embodiment, first, the vector c is provisionally set, and then the vector w is determined.

In the second embodiment, as shown in FIG. 15, when such a color distribution of image data as shown in FIG. 16 is given, an image frame (a group of image frames) to be determined as an object of calculation of a color balance vector is determined from an associated input image by the calculation object image frame setting section 21 (step S11). Then, in the color balance vector calculating section 22, a normalized color balance vector V is determined by using pixel data (Dx, Dy) of the image frame determined as the object of the calculation, as explained above with reference to FIG. 5 or 6 (step S12).

Next, in the illumination condition setting section 24, the maximum color display vector cₘ=(dx_{c}, dy_{c}) is determined (step S31). This is carried out in the following manner:

First, as shown in FIG. 16, pixel data on the color distribution is projected on an axis perpendicular to the color balance vector V, and the frequency of occurrence is calculated. Then, boundary lines u₁ and u₂ of the color distribution, which indicate the maximum and minimum of the frequency of occurrence, and are parallel the color balance vector V, are determined. Next, a vector cₓ whose origin point is located on an arbitrary point on the color balance vector V, and whose end point is located on the boundary line u₁, is determined, the vector cₓ being parallel to an axis Dx. Similarly, a vector c_{y} whose origin point is located on an arbitrary point on the color balance vector V, and whose end point is located on the boundary line u₂, is determined, the vector c_{y} being parallel to an axis Dy. The vectors cₓ and c_{y} respectively indicate Dx and Dy components of the maximum color display vector cₘ. That is, they satisfy the following relationship: cₘ=(dx_{c}, dy_{c}).

In the input image, the displayable range ensured in a method used in the second embodiment is a range within which a rectangular area having sides corresponding to the vectors cₓ and c_{y} is moved such that the origin point of each of the vectors cₓ and c_{y} is moved along the vector w from one end thereof to the other. It is preferable that the above rectangular area having sides corresponding to the vectors cₓ and c_{y} be set to have a size and a shape, which enable an image corresponding to given image data to be fully displayed over the color distribution 101 of the given image data. Therefore, the image is more fully displayed over the color distribution 101, when the end points of the vectors cx and cy are located at points at which the maximum values dx and dy of the color distribution 101 of the image data and the boundary lines u₁ and u₂ intersect each other, respectively, as shown in FIG. 16.

It should be noted that the boundary lines u₁ and u₂ are not necessarily determined to indicate the maximum and minimum of the frequency of occurrence. That is, it suffices that they are determined based on a predetermined reference regarding the quality of a displayed image.

After the maximum color display vector cₘ which satisfies cₘ=(dx_{c}, dy_{c}) is determined, the maximum color balance vector wm which satisfies wₘ=(dx_{w}, dy_{w}) is determined (step S32). The components dx_{w} and dy_{w} of the vector wₘ is calculated by the following equation (13):

$$\{ \begin{matrix}ⅆ {x}_{w} = ⅆ x - ⅆ {x}_{c} \\ ⅆ {y}_{w} = ⅆ y - ⅆ {y}_{c}\end{matrix} \qquad ( 13 )$$

It should be noted that dx and dy may be the maximum values of the color distribution, or may be determined based on the predetermined reference regarding the quality of a displayed image. However, when dy and dy are not the maximum values, there is a case where the displayed image does not cover the color range of the input image data. Thus, it is necessary to replace data not falling within the range by any data falling with in the range. This replacement can be achieved by, e.g., the above method explained with reference to FIG. 12.

Then, if the vectors cm and wm are provisionally set, the range of the displayable color is defined from the above provisionally set vectors wₘ and cₘ (step S15). Then, it is determined whether or not the range of the displayable color covers the color distribution of the image frame (group of image frames) determined as the object of the calculation (step S16). When it is determined that the range of the displayable color does not cover the above color distribution, the step is returned to the above step S31, and the successive steps from the step S31 are repeated, after changing the maximum color display vector cₘ (cₘ=(dx_{c}, dy_{c})).

On the other hand, in the step S16, when it is determined that the range of the displayable color covers the color distribution, the steps S17 to S22 are carried out as in the first embodiment. However, in the step S22, when it is determined that the set range of the displayable color of illumination light does not cover the color distribution of an image frame (group of image frames) determined as an object of calculation, the step is returned to the above step S31.

### THE THIRD EMBODIMENT

The third embodiment of the present invention will be explained. An image projecting apparatus according to the third embodiment can be applied to the case where profile data is already added as header information to the input image data.

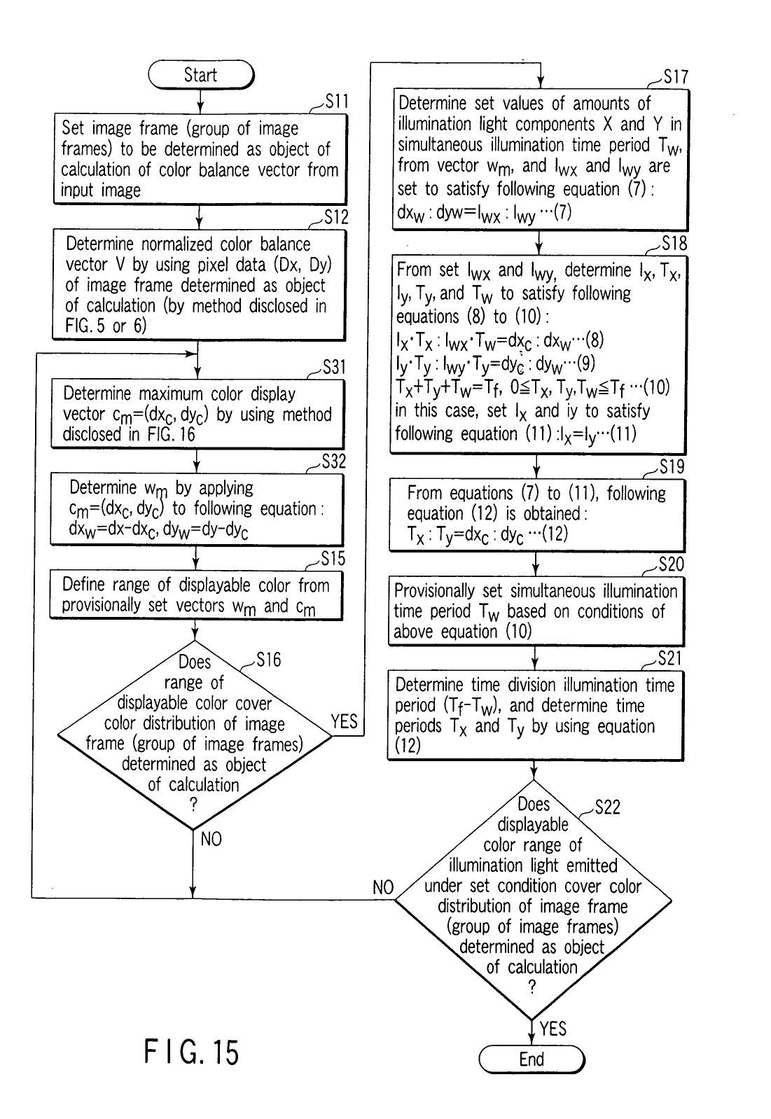

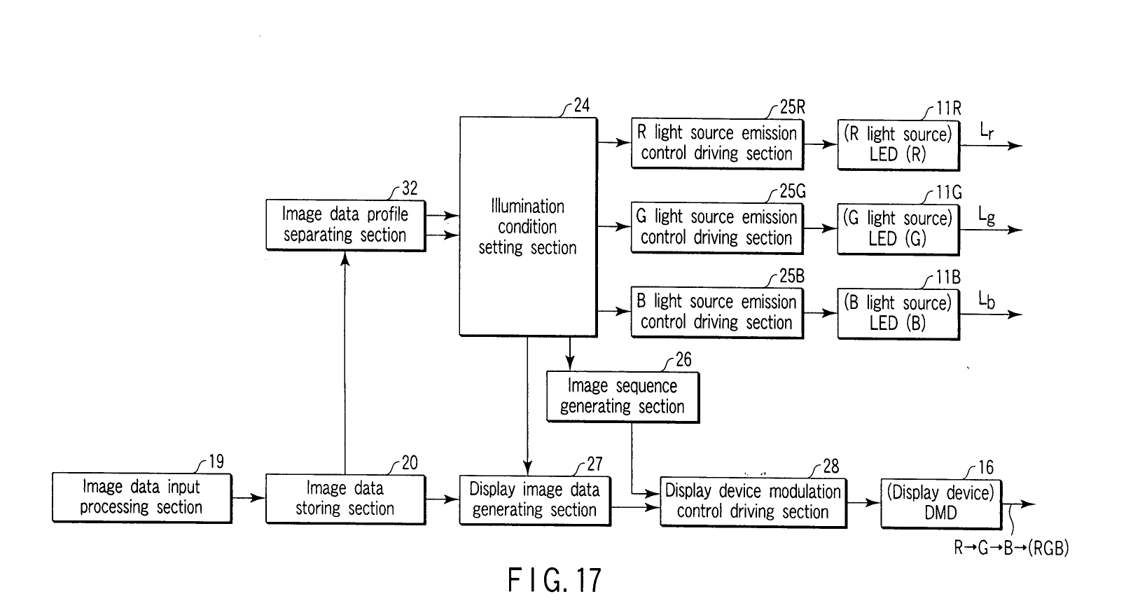

Unlike the image projecting apparatus according to the first embodiment, the image projecting apparatus according to the third embodiment does not have a function of calculating a color balance vector with respect to each of input images. That is, as can be seen from FIG. 17, the image projecting apparatus according to the third embodiment does not have any of the calculation object image frame setting section 21, the color balance vector calculating section 22, the mode switching section 23, the color balance vector recording section 29, the image data kind setting and inputting section 30 and the color balance vector selecting section 31. Instead, the image projecting apparatus according to the third embodiment includes an image data profile separating section 32 which separates an image data profile from input image data stored in the image data storing section 20.

Input image data 105 which is input to the image data input processing 19, and stored in the image data storing section 20 has such a format as shown in FIG. 18. To be more specific, the input image data 105 comprises an image data profile 105a, R (red) image data 105b, G (green) image data 105c and B (blue) image data 105d. The image data profile 105a includes information 105a1 on a color balance vector which is to be applied to the input image data 105 and maximum values 105a2, 105a3 and 105a4 of the above image data, i.e., the image data 105a, the image data 105b and the image 105c. Therefore, the image data profile separating section 32 can separate necessary information from the image data profile 105a, and give it to the illumination condition setting section 24. That is, the processing to be performed can proceed to a process of setting a projection condition without the need to calculate the color balance vector as in the first and second embodiments. It should be noted that the above format of the data is an example of the format of one data unit of a frame image. However, a predetermined group of image data pieces may have the same image data profile 105a. In this case, data (image frame ID 105a5 and imputed file name 105a6) for specifying a frame to which the image data profile 105a is applied is added.

In such a manner, the input image data 105 includes the image data profile 105a in which information on an area in which the image data is distributed in color space is stored in advance, and the image data profile data separating section 32 reads the information on the area from the image data profile 105a, thereby recognizing the area. In this case, the image data is input in units of one image file, and the image data profile 105a stores information on an area in which image data is distributed in the color space in units of one image file. Alternatively, the image data is input as moving image data, and the image data profile 105a stores information on an area in which image data on scenes each produced by one group of frames in the moving image data is distributed in the color space. In this case, one group of frames corresponds to one scene in the moving image data.

### THE FOURTH EMBODIMENT

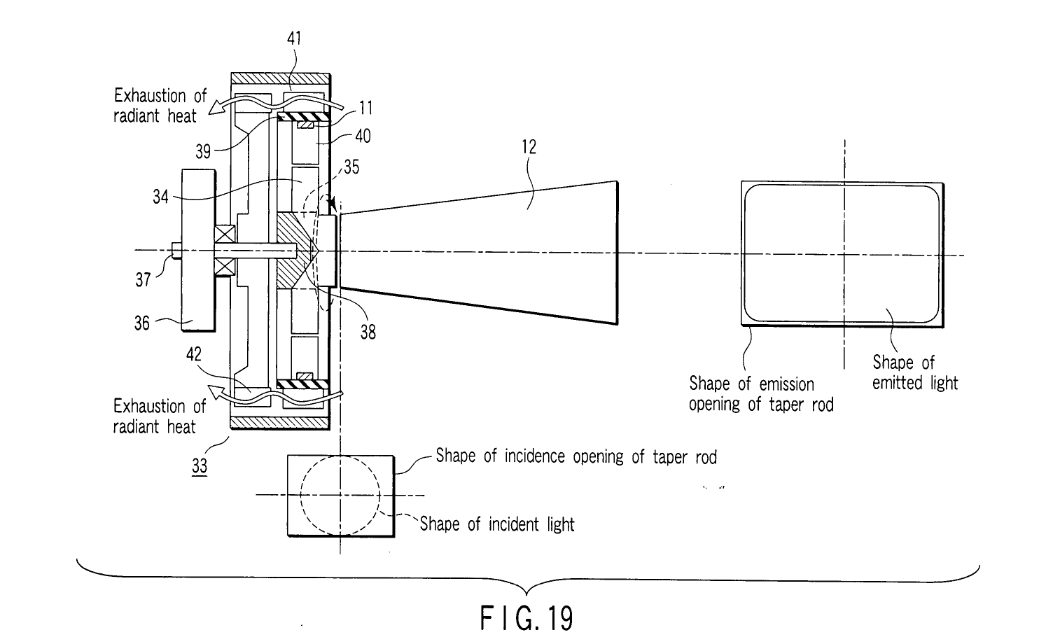

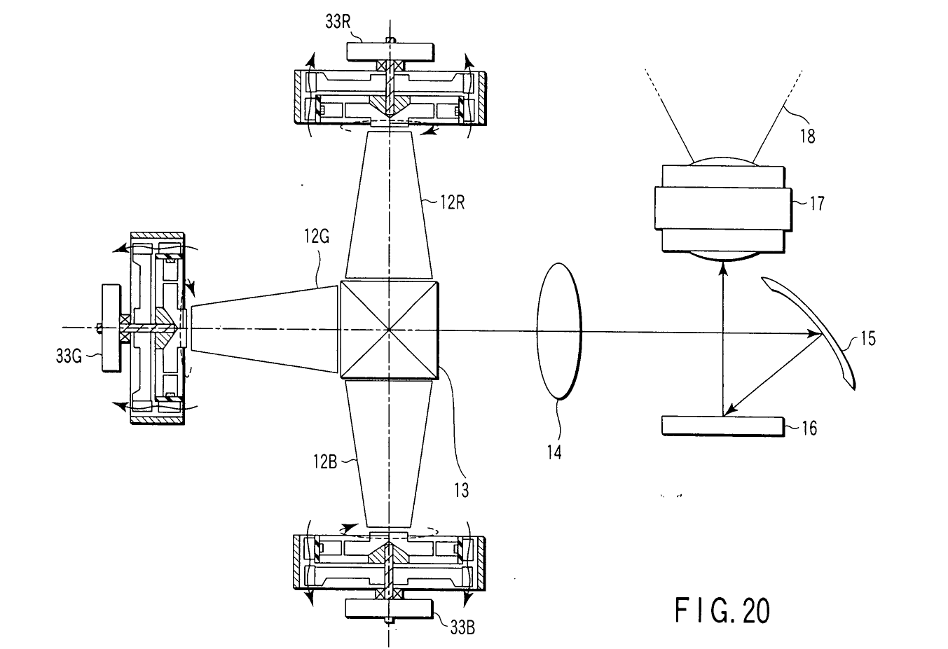

FIG. 19 is a view showing the structure of a light engine 33 for use in an image projecting apparatus according to the fourth embodiment of the present invention. FIG. 20 is a view showing the structure of the image projecting apparatus according to the fourth embodiment, to which a single plate method using such light engines is applied. That is, the image projecting apparatus according to the fourth embodiment has the same structure as that in FIG. 1, with the exception of the following: the image projecting apparatus according to the fourth embodiment uses light engines 33R, 33G and 33B as light sources, instead of the LEDs 11R, 11G and 11B.

Each of the light engines 33R, 33G and 33B will be hereinafter referred to as the light engine 33, and has such a structure as shown in FIG. 19. Specifically, in the light engine 33, parallel rods 34 and reflecting prisms 32 are formed as single body, thereby forming light guiding member. The light guiding member is held by a rod holder 38 coupled with a rotational shaft 37 of a rotating motor 36, and is rotated at a high speed in a direction indicated by an arrow in FIG. 19. Then, a plurality of LEDs 11 serving as light sources, which are arranged on an inner peripheral surface of a drum-shaped luminous board 39, are successively lit in accordance with rotation of the light guiding member. In this case, parallel rods 40 are fixedly provided for incidence surfaces which are end faces of the parallel rods 34, as light guiding portions for guiding diffused light from the LEDs 11, respectively. In the light engines having the above structure, the parallel rods 34 change in position in accordance with the above rotation, and the LEDs 11 are successively lit in is accordance with the position change of the parallel rods 34. Diffused light from the lit LED 11 is guided by the parallel rod 40 associated with the lit LED 11, and is then output from an emission surface of the above parallel rod 40, and is incident on an incidence surface of the parallel rod 34 moved to the parallel rod 40, the incidence surface of the parallel rod 34 being located to face the emission surface of the parallel rod 40. Then, the light is reflected by the reflecting prism 35 associated with the above parallel rod 40, and is then output from an emission surface of a taper rod 12.

Furthermore, radiation plates 41 are provided at an outer peripheral surface of the drum-shaped luminous board 39, and radiate heat generated due to emission of light from the LEDs 11, thus preventing variation of the characteristics of the LEDs 11. Thus, even if each of the light engines 33 is continuously operated, light can be emitted stably. Furthermore, each light engine 33 comprises a radiation fan 42 for exhausting air contacting the radiation plates 41. The radiation fan 42 is coupled with the shaft of the rotating motor 36 for rotating the light guiding member, i.e., the rod holder 38. Therefore, the radiation fan 42 is rotated at the same time as the light guiding member is rotated by the rotating motor 36, as a result of which air contacting the radiation plates 41 can be exhausted. In such a manner, the rotating motor 36 for rotating the light guiding member doubles as the motor for the radiation fan 42 for radiating heat of the LEDs 11. Thus, two functions can be achieved by a single driving source. Accordingly, since the driving source is effectively used, the space to be used can be reduced, and power can be more effectively used.

The light engines 30 each having the above structure make the LEDs 11 successively emit pulse light components, and their relative positional relationships with the light guiding members for guiding the light components are selectively changed in accordance with switching of emission of the LEDs 11. As a result, the LEDs 11 can emit light having a high effective brightness, and a large amount of light having an improved parallelism can be output from the emission ends of the light guiding members. Furthermore, the parallel rods 40 for guiding diffused light components from the LEDs 11 to the light guiding members are provided for the LEDs 11, respectively. Thus, even if the LEDs 11 were not provided at a small pitch, the light components could be guided by the parallel rods 40 such that they travel as if they were emitted from the LEDs 11 which were arranged at a small pitch. By virtue of the above feature, the pitch at which the LEDs can be arranged can be ensured, and the display device can be more easily designed. In addition, actually, the LEDs 11 can be arranged at a small pitch, the light guiding members reliably take in the light components, i.e., the amounts of the light components taken in by the light guiding member are not reduced. Therefore, emission of the light components can be reliably achieved.

The light engines 33 can serve as the R light engine 33R, G light engine 33G and B light engine 33B, respectively, as shown in FIG. 20, by having LEDs 11 for emitting red (R), green (G) and blue (B) light components, respectively. Then, it suffices that the amounts of the light components emitted from the LEDs 11 at each light engine 33 are controlled in the same manner as in the first to third embodiments.

In each light engine 33, the light emitted from the reflecting prism 35 is incident onto an incidence opening of the taper rod 12 which is fixed by a holding mechanism not shown which is not rotatable, so as to have such a circular incident light shape. The incidence opening of the taper rod 12 is rectangularly shaped to satisfy the condition that the incident light shape is substantially inscribed in the incidence opening. The light incident onto the taper rod 12 is output from an emission opening of the taper rod 12 as illumination light having such a substantially rectangular shape as shown in FIG. 19. In such a manner, illumination light having a rectangular shape can be obtained. Thus, when the illumination light is incident onto the DMD 16 serving as a display device having a rectangular light-receiving surface, it can be efficiently utilized, since its shape is coincident with the light-receiving surface of the DMD 16.

### THE FIFTH EMBODIMENT

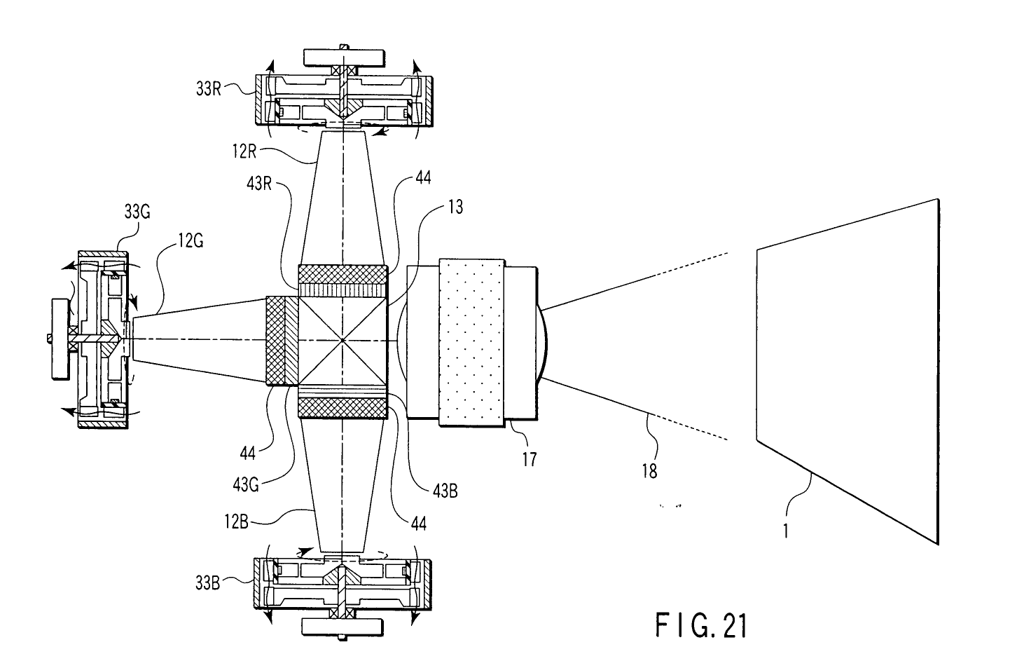

An image projecting apparatus according to the fifth embodiment is a three-plate type image projecting apparatus provided with such light engines as explained with respect to the fourth embodiment. The image projecting apparatus according to the fifth embodiment, as shown in FIG. 21, includes display devices (R display device 43R, G display device 43G and B display device 43B) respectively provided for the colors of images to be projected on the screen 1. The display devices 43R, 43G and 43B are controlled by the display device modulation control driving section 28 to form images such that the images do not overlap each other in the time division illumination time period, and they are formed at the same time in the simultaneous illumination time period. The display devices 43R, 43G and 43B are respectively provided on the emission opening sides of the taper rods 12R, 12G and 12B for guiding the light components from the light engines 33R, 33G and 33B, i.e., the incidence openings of the dichroic cross prism 13. On the emission opening sides of the dichroic cross prism 13, projecting lenses 17 are provided. Light components optically modulated in accordance with the images displayed by the display devices 43R, 43G and 43B are guided to the projecting lens 17 by the dichroic cross prism 13, and are then projected as projection light 18 on the screen 1.

The above display devices 43R, 43G and 43B are light transmission type liquid crystal devices. Therefore, light converting elements 44 are provided between the taper rods 12R, 12G and 12B and the display devices 43R, 43G and 43B in order to permit only light components having a predetermined polarizing angle to pass through the light converting elements 44. In addition, although illustrations of polarizing plates will be omitted in the drawings, they are provided on the output sides (light emitting sides) of the display devices 43R, 43G and 43B.

### THE SIXTH EMBODIMENT

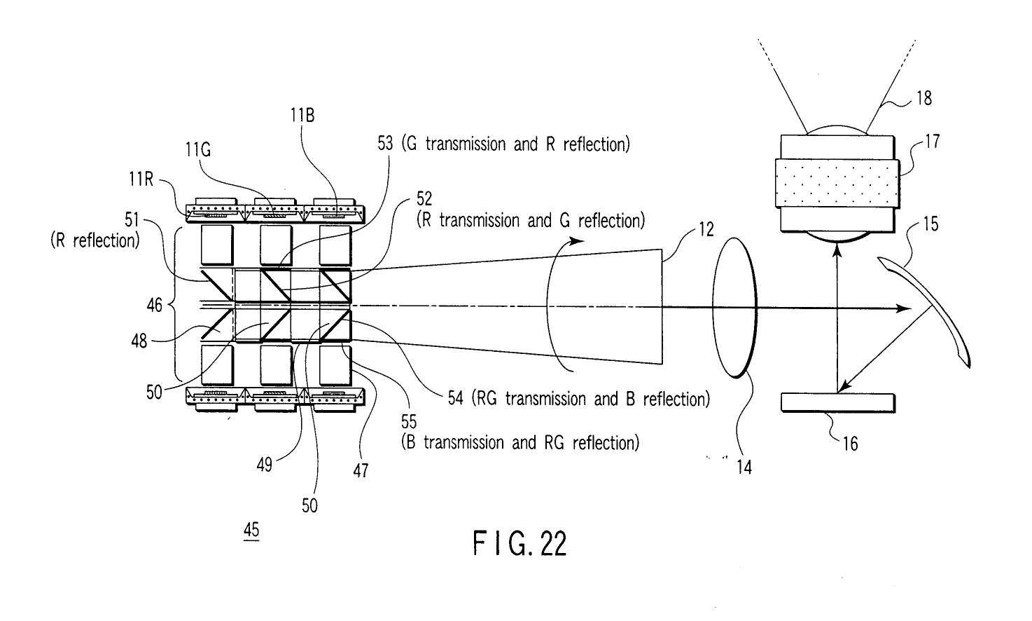

An image projecting apparatus according to the sixth embodiment is a single-plate type image projecting apparatus including light engines each having a structure which differs from those of the above light engines. Specifically, as shown in FIG. 22, the image projecting apparatus according to the sixth embodiment includes a light engine 45 in which LEDs 11R, 11G and 11B are mounted on inner peripheries of drum-shaped boards at three stages. To be more specific, the LEDs 11R, 11G and 11B at the stages emit red (R), green (G) and blue (B) light components, respectively. Further, single-unit movable section 46 is provided inward of the drum-shaped boards, and comprises six parallel rods 47, two triangular prisms 48, fourth light guiding pipes 49 and four dichroic prisms 50 and one taper rod 12.

Referring to FIG. 22, at the leftmost one of the stages, the LEDs 11R for emitting red (R) light components are provided, and at diagonal surfaces of the associated triangular prisms 48, mirror coats 51 for reflecting light having a red (R) wavelength band are provided, as described with a parenthesized expression in FIG. 22. No elements are provided at the sides of the triangular prisms 48 which are closer to the LEDs 11R, i.e., incidence surfaces of the triangular prisms 48 which are located close to the parallel rods 47. Furthermore, at the center stage, the LEDs 11G for emitting green (G) light components are provided, and at the diagonal surfaces of the associated dichroic prisms 50, dichroic coats 52 which permit light having a red (R) wavelength band to be transmitted therethrough, and reflect light having a green (G) wavelength band are provided. In addition, dichroic coats 53 which permit light having a green (G) wavelength band to be transmitted therethrough, and reflects light having a red (R) wavelength band are provided on the sides of the dichroic prisms 50 which are closer to the LEDs 11G, i.e., incidence surfaces of the dichroic prisms 50 which are located close to the parallel rods 47. At the rightmost stage, the LEDs 11B for emitting blue (B) light components are provided, and at the diagonal surfaces of the associated dichroic prisms 50, dichroic coats 54 which permit light having red (R) and green (G) wavelength bands to be transmitted therethrough, and reflect light having a blue (B) wavelength band. In addition, dichroic coats 55 which permit light having a blue (B) wavelength band to be transmitted therethrough, and reflects light having red (R) and green (G) wavelength bands are provided on the sides of the dichroic prisms 50 which are closer to the LEDs 11B than the other sides, i.e., incidence sides of the dichroic prisms 50 which are located close to the parallel rods 47. It should be noted that the triangular prisms 48 may be replaced by dichroic prisms.

In the light engine 45 having the above structure, the single-unit movable section 46 is attached to a rotatable holding member not shown, and is rotated by a rotating motor not shown in a direction indicated by an arrow in FIG. 22. Furthermore, the LEDs 11R, 11G and 11B serving as a plurality of light sources which are arranged on the inner peripheries of the drum-shaped boards are successively lit in accordance with the rotation of the single-unit movable section 46. That is, the LEDs 11R, 11G and 11B are successively lit to perform pulse emission, and their relative positional relationships with incidence ends of the single-unit movable section 46 are selectively changed in accordance with switching in emission between the LEDs 11R, 11G and 11B. Consequently, the LEDs 11R, 11G and 11B can emit respective red, green and blue light components which have effective high brightness, and large amounts of red, green and blue light components which have improved parallelism can be obtained from emission ends of the taper rods 13 which serve as emission ends of the single-unit movable section 46.

### THE SEVENTH EMBODIMENT

The first to sixth embodiments are explained by referring to the case where the image projecting apparatus is applied to a so-called projector for projecting an image on the screen 1. However, the image projecting apparatus can be applied to various kinds of apparatuses other than the projector.

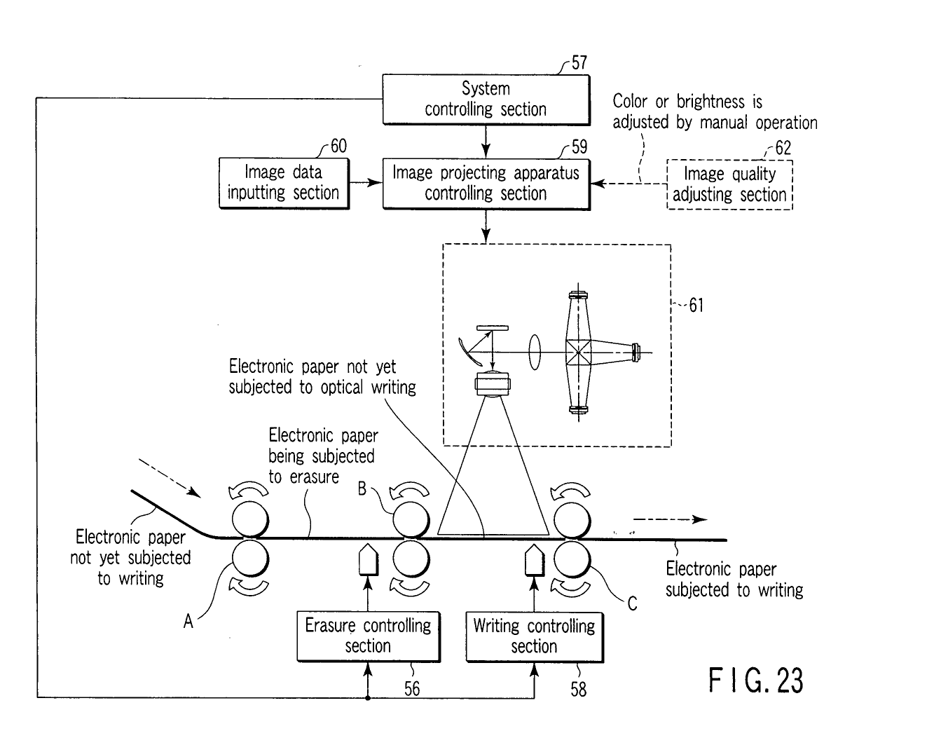

For example, as shown in FIG. 23, the image projecting apparatus can be applied to a rewritable electronic paper recording apparatus. The rewritable electronic paper recording apparatus shown in FIG. 23 is a rewritable electronic paper recording apparatus in which data can be optically written on a rewritable electronic paper by charging it.

More specifically, in the rewritable electronic paper recording apparatus according to the seventh embodiment, a rewritable electronic paper where an image and a character are written is transferred to a predetermined position by a transfer roller A, and they are erased in response to a signal output from an erasure controlling section 56. The way of erasing them varies in accordance with the characteristics of rewritable electronic papers. For example, there is a way in which an erasure electric field is applied to the entire electric paper. Then, the rewritable paper is transferred to a predetermined rewritable position by a transfer roller B. Setting of the position of the electronic paper is detected, a writing command is issued from a system controlling section 57, and a signal for instruction is input to a writing controlling section 58, thereby making the electric paper enter a writing state (the illustration of these operations will be omitted in the drawings). For example, an electric field for writing is applied to the electronic paper. In this state, a command for projecting image data input from an image data inputting section 60 is given to an image projecting apparatus controlling section 59. In response to the command, an image projecting section 61, which comprises such an image projecting apparatus as explained with respect to any of the first to the sixth embodiments, e.g., the image projecting apparatus according to the first embodiment, is controlled to project an image, and optically write image data on the electronic paper. Thereafter, the electric paper is transferred to the outside of the apparatus by a transfer roller C.

In such a manner, image data can be written on the electronic paper by using the image projecting section 61 which comprises such an image projecting apparatus as explained with respect to any of the first to the sixth embodiments. Thus, the operation can be performed at a higher speed. Furthermore, due to use of the image projecting apparatus according to any of the first to the sixth embodiments, the colors of illumination light components can be easily adjusted by an image quality adjusting section 62. In particular, the advantage of the seventh embodiment is more remarkable when a color image is recorded, since the color of the recorded image is satisfactory.

Moreover, application of the image projecting apparatus of the present invention is not limited to the rewritable electronic paper recording apparatus. That is, if the image projecting apparatus of the present invention is applied to a structural member for projecting an image, such as a photographic exposure apparatus, a color copying machine, or a color printer, the structural member can be provided as effective image forming means, since its color adjustment can be easily performed.

As described above, the present invention is explained by referring to the above embodiments; however, it is not limited to the embodiments. For example, the color balance vector calculating section 22 may be formed to determine the maximum values of data pieces on the colors, which are included in the input image data, and recognize an area in which the image data is distributed, by using the above maximum values.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. An image projecting apparatus for projecting an image based on input color image data, comprises:
an illuminating section configured to emit illumination light components of colors such that an amount of each of the illumination light components of colors is adjustable in accordance with a driving current value and a driving time period;
a display device configured to perform modulation processing based on a color image data piece of the input color image data which is associated with one of the illumination light components of colors which is emitted from the illuminating section;
an expression area setting section configured to set an expression area in a color space, in which expression is performable when the illumination light components emitted by the illuminating section are modulated by the display device; and
an illumination light amount controlling section configured to appropriately control an amount of each of the illumination light components emitted from the illuminating section in each of frame time periods, in accordance with the color image data and the expression area set by the expression area setting section.

2. The apparatus according to claim 1, wherein the illumination light components are red (R), green (G) and blue (B) illumination light components; and
the illumination light amount controlling section is configured to control the amounts of the red, green and blue illumination light components.

3. The apparatus according to claim 2, wherein illuminating section includes LED configured to emit red (R) illumination light component, LED configured to emit green (G) illumination light component, and LED configured to emit blue (B) illumination light component.

4. The apparatus according to claim 1, wherein the display device includes a plane sequential type display device configured to successively perform modulation processings associated with image data regarding the colors in the each of the frame time periods.

5. The apparatus according to claim 1, wherein
the each of the frame time periods includes first and second time periods, and
the illumination light amount controlling section is configured to control the amounts of the illumination light components of colors to be emitted by the illuminating section in different manners, in the first time period, the illumination light components being successively emitted at different timings, and in the second time period, at least two of the illumination light components being emitted at the same time.

6. The apparatus according to claim 5, wherein mixture of the at least two of the illumination light components which are emitted in the second time period is white.

7. The apparatus according to claim 5, wherein mixture of the at least two of the illumination light components which are emitted in the second time period has predetermined color.

8. The apparatus according to claim 5, further comprising a projecting section configured to project an image modulated by the display device which is illuminated by the illuminating section, such that the image is observable by an observer,
an image projected by the projecting section in the first time period being reproduced based on arbitrary color information which is included in the color image data, and
an image projected by the projecting section in the first and second time periods being reproduced based on brightness information on specific color which is included in the color image data.

9. The apparatus according to claim 8, further comprising an image data converting section configured to divide the input image data into image data corresponding to the image to be projected in the first time period and image data corresponding to an image to be projected in the second time period, such that an image corresponding to the input image data is projectable by the projecting section.

10. The apparatus according to claim 9, further comprising a distribution area recognizing section configured to recognize a distribution area in which the color image data is distributed in color space,
when the distribution area recognized by the distribution area recognizing section is larger than the expression area set by the expression area setting section, the image data converting section being configured to convert the color image data such that a value of part of the distribution area which is not within a displayable range is replaced by a maximum value of the displayable range.

11. The apparatus according to claim 10, wherein the image data converting section is configured to convert the color image data such that the value of the part of the distribution area which is not within the displayable range is replaced by a value of a position within the displayable range, whose Euclidean distance is the shortest in the color space.

12. The apparatus according to claim 10, wherein the image data converting section is configured to convert the color image data such that the value of the part of the distribution area which is not within the displayable range is replaced by a value of a position within the displayable range, which is located on a line extending between an origin point of the color space and the part of the distribution area.

13. The apparatus according to claim 5, wherein in the first time period, the illumination light amount controlling section is configured to control the driving time period with respect to each of the colors, the driving time period being a time period in which the illuminating section is driven.

14. The apparatus according to claim 5, wherein in the second time period, the illumination light amount controlling section is configured to control the driving current for use in driving the illuminating section with respect to each of the colors.

15. The apparatus according to claim 5, further comprising a distribution area recognizing section configured to recognize a distribution area in which the color image data is distributed in the color space,
the illumination light amount controlling section being configured to control the amount of the each of illumination light components of colors to be emitted by the illuminating section, based on the expression area set by the expression area setting section and the distribution area recognizing by the distribution area recognizing section.

16. The apparatus according to claim 15, wherein the expression area setting section is configured to set the expression area such that an area of the distribution area which is within the expression area is maximized.

17. The apparatus according to claim 16, wherein the expression area setting section is configured to set the expression area such that the number of image data pieces in an area of the distribution area which is within the expression area is maximized.

18. The apparatus according to claim 17, wherein
the image data pieces in the distribution area are weighted in accordance with positions corresponding to the image data pieces within the color space, and
the expression area setting section is configured to set the expression area such that the number of the image data pieces in the distribution area which are weighted and are within the expression area is maximized.

19. The apparatus according to claim 15, wherein when color vectors of the color image data within the color space are projected on arbitrary vectors, the distribution area recognizing section is configured to recognize and specify the distribution area in which the color image data is distributed, by using, as color balance vectors, arbitrary vectors in which distribution is maximum.

20. The apparatus according to claim 15, wherein the distribution area recognizing section is configured to determine maximum values of data pieces on the colors, which are included in the color image data, and to recognize the distribution area in which the color image data is distributed, by using the maximum values.

21. The apparatus according to claim 15, further comprising a mode switching section is configured to enable an observer to select one of first and second modes, and to effect switching between the first and second modes,
the first mode being provided as a mode in which the distribution recognizing section detects and determines an area in which the color image data is present in the color space, as the distribution area, and
the second mode being provided as a mode in which the distribution area recognizing section reads and determines a predetermined area stored in advance, as the distribution area.

22. The apparatus according to claim 21, further comprising a distribution area storing section configured to store in advance information regarding the area which is read when the second mode is selected.

23. The apparatus according to claim 22, wherein
the color image data is input to the image projecting apparatus in units of one image file, and
the distribution area storing section is configured to store in advance information regarding an area in which image data in each of image files is distributed in the color space.

24. The apparatus according to claim 22, wherein
the color image data is input as moving image data to the image projecting apparatus, and
the distribution area storing section is configured to store information regarding an area in which image data corresponding to respective series of frames in the moving image data is distributed in the color space.

25. The apparatus according to claim 24, wherein each of the groups of frames corresponds to an associated one of a series of scenes.

26. The apparatus according to claim 22, wherein
the distribution area storing section stores a plurality of kinds of information pieces including the information regarding the area, and
the apparatus further comprises an area selecting section configured to enable an observer to select one of a plurality of area information pieces stored in the distribution area storing section, as the information which is read when the second mode is selected.

27. An image projecting apparatus for projecting an image based on input color image data, comprises:
illuminating means for emitting illumination light components of colors such that an amount of each of the illumination light components of colors is adjustable in accordance with a driving current value and a driving time period;
a display device for performing modulation processing based on a color image data piece of the input color image data which is associated with one of the illumination light components of colors which is emitted from the illuminating means;
expression area setting means for setting an expression area in a color space, in which expression is performable when the illumination light components emitted by the illuminating means are modulated by the display device; and
illumination light amount controlling means for appropriately controlling an amount of each of the illumination light components emitted from the illuminating means in each of frame time periods, in accordance with the color image data and the expression area set by the expression area setting means.
